(19) United States
(12) Patent Application Publication
(10) Pub. No.: US 2002/0153669 A1
(43) Pub. Date: Oct. 24, 2002

(54) Closed metal elastic gasket with offset projecting parts

(76) Inventors: Philippe Caplain, Saint Paul Trois Chateaux (FR); Christian Rouaud, Bourg Saint Andeol (FR)

Correspondence Address: Robert E Krebs, Thelen Reid & Priest LLP, P O Box 640640, San Jose, CA, 95164-0640, US

(21) Appl. No.: 09/989,144

(22) Filed: Nov. 21, 2001

(30) Foreign Application Priority Data
Apr. 23, 2001 (FR) 01 05428

(51) Int. Cl. H02G 3/22

(52) U.S. Cl. 277/606

(57) ABSTRACT

The metal elastic gasket can tolerate considerable clamping forces without causing any degradation to sealing by possible deformation.

It consists of a metal core (12) enclosed in an outer envelope (13) that is more ductile. On the side, the latter has clearance surface areas (16) to be placed opposite the surface areas (1) enclosing the gasket (10), with a projecting part (14) placed so as to be offset with respect to centre axis (M) of the gasket. This avoids any decrease in the contact pressure of the gasket on the surface areas (1) during crushing, when the projecting part is centred.

### DESCRIPTION

1. Field of the Invention

The invention concerns static sealing, and in particular elastic metal gaskets to ensure tightness with clamping forces less than those needed for the efficiency of spring core gaskets.

2. Prior Execution and Problem Posed

Considering the choice of materials with respect to their insensitivity to corrosive fluids, and their performance at high and low temperatures and their durability in the course of time, metal gaskets are used in a wide variety of application areas, among which may be mentioned, although this is not considered limitative in any way, the chemical, petroleum and nuclear industries, as well as the automobile and space sectors. The quality of sealing offered by a gasket depends in particular on the specific pressure developed between the contact surfaces of the gasket and the assembly flanges between which the gasket is placed. During the initial tightening of the assembly, the specific contact pressure must be sufficient to allow the gasket to match the uneven surfaces of the flanges. Therefore, it is clear that the specific contact pressure must be relatively high and, in any case, greater than the pressure of the fluids prevailing inside the volume contained by the gasket and the gasket clamping surfaces.

Furthermore, in many applications, the tightening force has to remain low. This is particularly so when the assembly is difficult to reach, making it awkward to handle the attaching tools, as is the case in the nuclear industry and the semiconductor industry, and when the assemblies using materials with demanding properties have to be lightweight and will not support high forces, as is the case in the aeronautical and space industries. To obtain a result like this, metal O-rings have been developed using as elastic element an open tube, preferably enclosed by a fine coat of ductile material. Each contact surface has a part projecting in line with the section of the O-ring at right angles to the surfaces of the clamping faces. This makes it possible to decrease by a factor of 2 the tightening forces on this type of gasket. Conversely, for this type of gasket, it is difficult to master the exact points of contact in operation, i.e., once the gasket has been crushed. Indeed, during the crushing of the gasket, its deformation will not allow the precise localizing of these point of contact which move perpendicularly to the crushing direction.

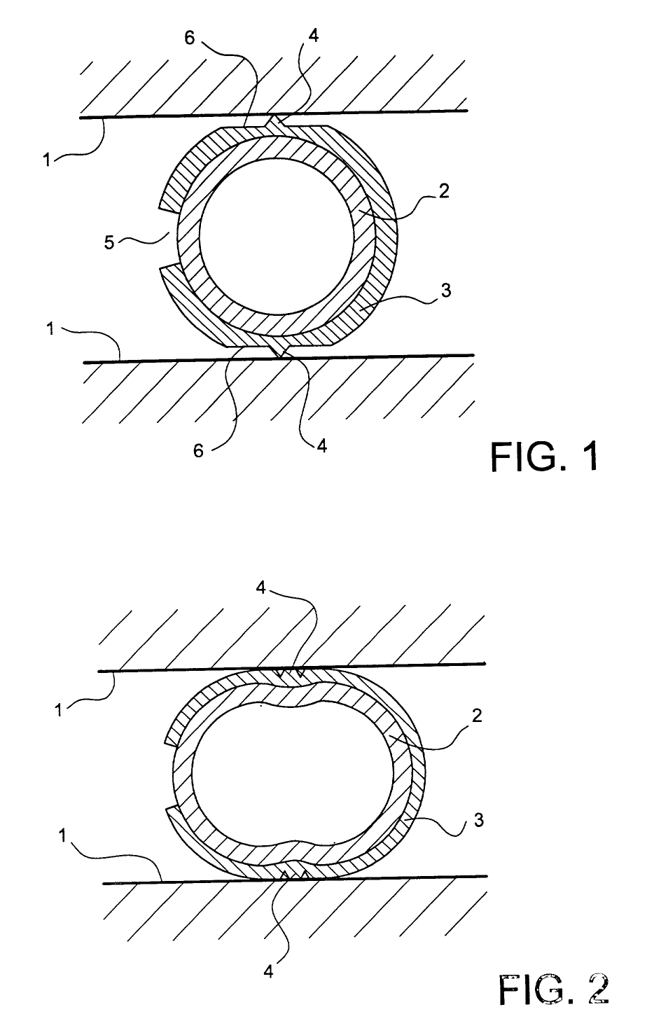

In addition, from French patents No. 2 636 115, we are familiar with a metal gasket having a very high specific pressure with a closed structure. FIG. 1 shows the section of a gasket like this. It is suitable for obtaining tightness with a low tightening force while being capable of resisting high temperatures and pressures. It includes a metal core 2 which is elastic and has a circular and closed section. An outer envelope 3 of relatively ductile metal encloses it. It may be closed or have a side opening 5.

This gasket is placed between two pieces 1 forming confined spaces which have to be sealed off from one another. To obtain tightness with a low tightening load, there are two clearance surfaces 6, opposite one another and placed each opposite a piece 1, a projecting part 4, having an approximately triangular section over the entire length of the sealed.

Conversely, as can be seen in FIG. 2, after the application of tightening force, the projecting parts 4 are, naturally, partially crushed but the pressure they impart to outer envelope 3 and metal core 2 causes the latter to deform. Therefore, the gasket tends to take on a figure-8 shape and lose all of the mechanical properties due to its cylindrical tubular form. In particular, it is evident that the figure-8 deformation of the gasket modifies its contact zone on the pieces 1 between which it is clamped. Modelling confirms that the specific pressure developed at the beginning of crushing, at projecting part 4, decreases gradually as the crushing force increases, spreading onto the two adjacent and symmetrical areas of clearance surfaces 6 either side of the projecting part.

The purpose of the invention is therefore to overcome this drawback by proposing a different type of metal gasket.

### SUMMARY OF THE INVENTION

For this purpose, the main goal of the invention is to obtain a closed metal elastic gasket consisting of an elastic metal core and an outer envelope, of ductile material, into which the metal core is inserted. When idle, the gasket has a closed circular cross-section defining a centreline i.e. a straight line passing through the geometrical centre of the idle gasket section. The latter has two clearance surfaces placed opposite each other each having a projecting part the apex of which is designed to come into close contact with an object under the effect of a determined tightening force.

According to the invention, when idle, the projecting parts are offset slightly either side of the middle axis of the gasket.

In a preferential execution of the invention, the two clearing surfaces are parallel to each other and each is perpendicular to the axis of symmetry of the projecting part associated with it.

In many executions of the gasket according to the invention, it is generally annular in shape. In this case, the opening can be placed toward the axis of symmetry of the gasket, or opposite it.

The gasket can also be of different shapes, for instance, elliptical, triangular or rectangular.

The projecting parts may be of several shapes, for instance, generally triangular, generally trapezoidal, generally elliptical or generally rectangular.

Preferably, the height of the projecting parts, more or less triangular in section, is included between 0.25 and 0.50 mm.

One particularly advantageous alternative consists of using on each clearance surface area two projecting parts placed on either side of the centreline.

### LIST OF ILLUSTRATIONS

The invention and its various properties will be better understood with reference to the following description which is illustrated by the figures representing respectively:

FIG. 1, already described, a sectional view showing the section of an elastic metal gasket according to the prior execution;

FIG. 2, already described, a sectional view of the same gasket according to the prior execution as shown in FIG. 1, but after crushing;

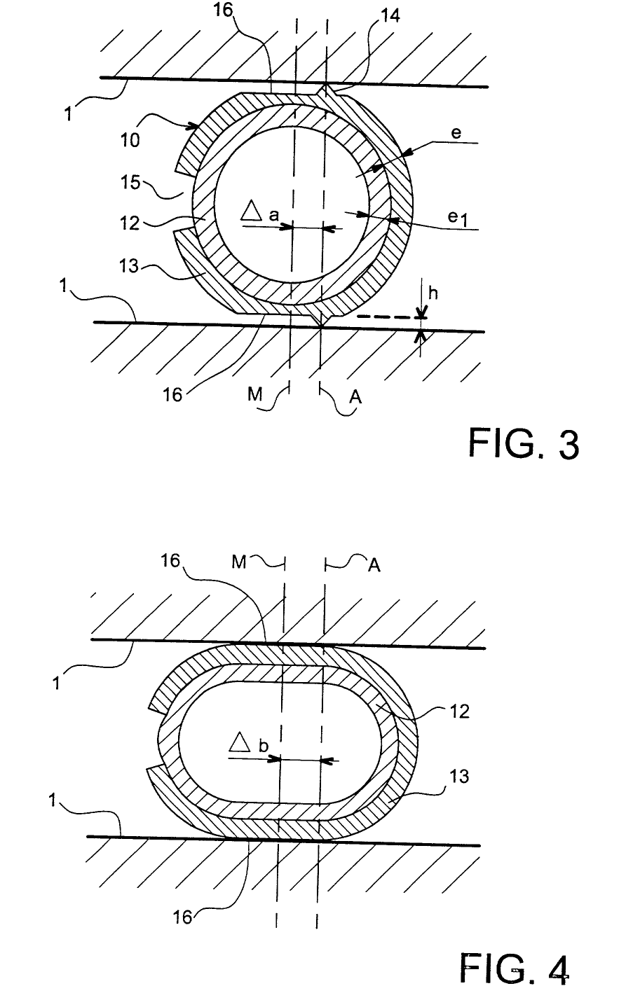

FIG. 3, a sectional view of a metal elastic gasket according to the first execution of the invention, before crushing;

FIG. 4, a sectional view of the same gasket according to the invention as shown in FIG. 3, but after crushing;

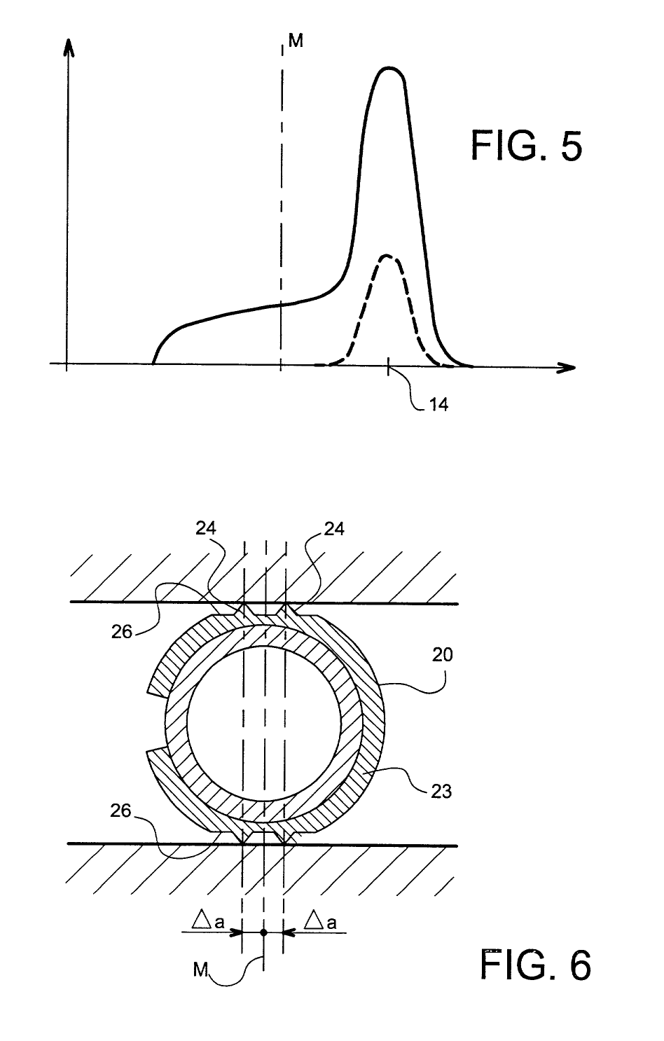

FIG. 5, two characteristic curbs of this metal elastic gasket according to the invention;

FIG. 6, a sectional view showing the section of an elastic metal gasket according to the invention, in a second execution;

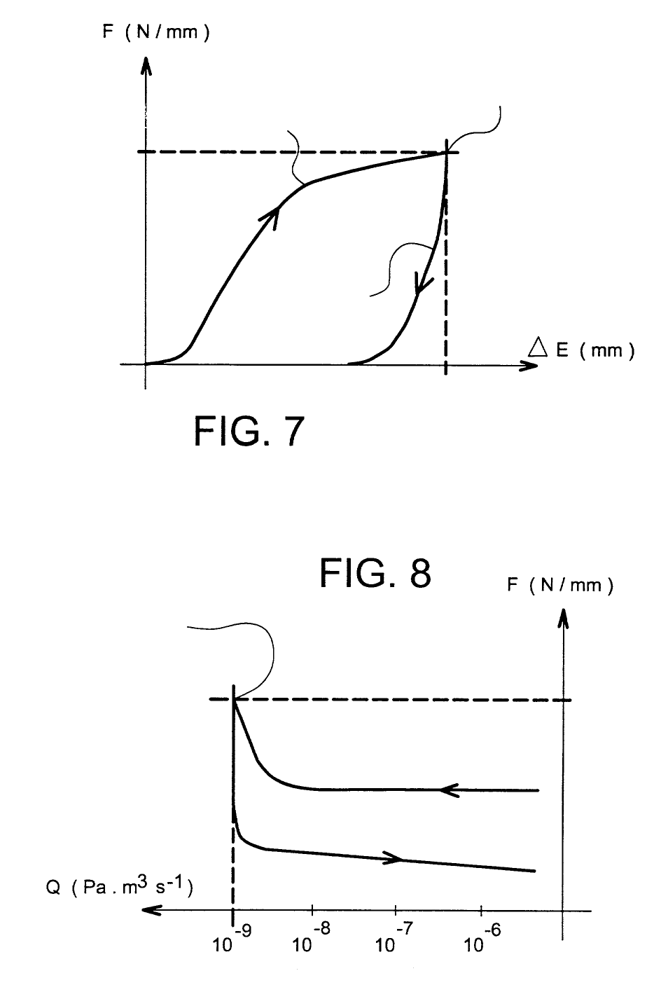

FIGS. 7 and 8, showing characteristic curbs of the operation of the metal gaskets according to the invention;

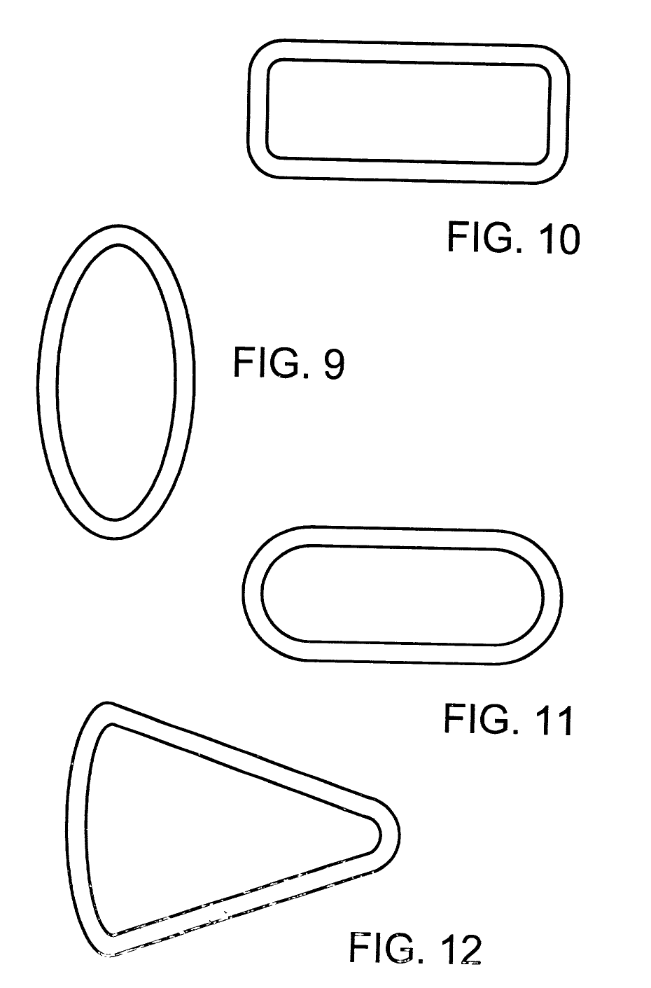

FIGS. 9 to 12, showing the various shapes that the gasket can take; and

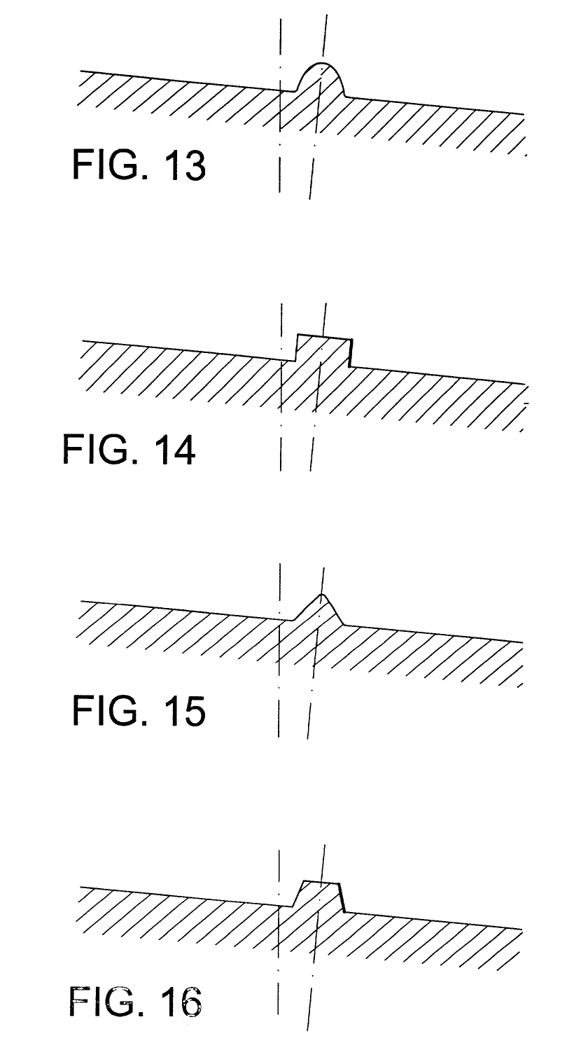

FIGS. 13 to 16, showing the various shapes that the projecting parts can take.

### DETAILED DESCRIPTION OF TWO EXECUTIONS OF THE INVENTION

FIG. 1 shows a first execution of a metal elastic gasket according to the invention before it is crushed. Compared to FIG. 1, we have the same two parts 1 which will crush the gasket 10. In a similar way, the gasket has a metal core 12, enclosed by outer envelope 13.

The metal core 12 is more often than not made of hardened stainless steel, but can also be made of a neutral or titanium alloy. The outer envelope 13 can be made of highly ductile materials such as aluminium, gold or copper, or less ductile materials like nickel or stainless steel or materials of similar ductility.

On the clearance surface areas 16, arranged so as to be parallel to each other at the points of the surface of outer envelope 13 that has to come into contact with pieces 18, there is always a projecting part 14. As schematised by the position of the two axes, the middle axis M of gasket 10 and an axis A passing through the apexes of the two projecting parts 14, the two latter are offset with respect to the middle axis M. in other words, on each of the clearance surfaces 16, there is a projecting part 14 offset with respect to the centre of the same clearance part 16. Note that the two projecting parts 14 are offset to the same side. Let us take this opportunity of indicating that the presence of opening 15 in outer envelope 16 is not obligatory and can be placed on any side of gasket 10. Indeed, the deformation of the tubular section of the gasket maintains symmetry during the crushing phase, because of the symmetry of the gasket.

The height h of the projecting parts 14 depends on the thickness e13 of outer envelope 13. For the thickness values e13 of the envelope 13 included between 0.25 mm and 1 mm, the height h of the projecting parts 14 is approximately 10 to 15% of the thickness e13.

The offset □a between the middle axis M of the projecting parts 14 is obtained by modelling the contact pressure. Its value depends on the outside diameter of the tube forming the metal core 12, the thickness e12 of the metal core 12 and the desired crushing factor. For a habitual crushing factor of around 10%, offset □a will vary between 0.150.30 mm for metal two diameters ranging from 3 to 4 mm.

After symmetrical crushing, FIG. 4 shows that the offset □b between the middle axis M and the axis A of projecting parts 14 is greater than the offset □a of these two axes before crushing. It is also evident that the clearance surfaces 16 tend to come into contact over a relatively large area with contact parts 1. This appears when the ductility of the outer envelope 13 is particularly high.

In superimposition, FIG. 5 shows the distribution of the contact pressure over surface area 16 for crushing of 0.30 mm (dotted line curve) and for crushing of 1 mm (solid line curve). It is evident that the contact pressure is, obviously, maximum at the projecting part 14.

FIG. 6 shows a second execution of the metal gasket according to the invention.

As can be seen, the main new feature of this second metal gasket 20 is the presence, on each of clearance surfaces 26 of outer envelope 23 of two projecting pieces 24. These pieces are placed either side of the middle axis M of metal gasket 20. Therefore, they are designed to tolerate the slightly higher crushing forces applied symmetrically. In addition, the presence of the two projecting pieces 24, separated by a small space, can act as to sealing barriers.

FIG. 7 shows a gasket crushing curve according to the invention. This curve is representative of the relation between the linear clamping force F, proportional to the crushing force E of the gasket.

FIG. 8 shows the leakage value Q in proportion to the linear force F.

On these two curves, it is necessary to allow for the orientation of the arrows denoting the direction in which the gasket tightening and loosening process takes place. In many executions of the gasket according to the invention, it is generally annular in shape.

In other executions of the gasket according to the invention, it may be elliptical (FIG. 9), rectangular, generally rectangular with rounded corners (FIG. 10), triangular, oblong (FIG. 11) or take one of the other shapes resulting from a combination and/or modification of these shapes (FIG. 12).

In the case referred to here, the height of the projecting parts, having an approximately triangular section, is included between 0.25 and 0.50 mm.

For a more or less triangular section, the height is measured perpendicular to the surface 16 from the apex of the projecting parts to this surface. In other executions of the gasket according to the invention, the projecting parts may be elliptical (FIG. 13), rectangular, generally rectangular with rounded corners (FIG. 14), triangular (FIG. 15), trapezoidal (FIG. 16) or may take any on any other shape. For a section that is approximately trapezoidal, rounded or of another shape, the height is measured perpendicular to surface 16 from the apex of the projecting part to said surface.

1. A elastic metal closed gasket (10, 20) having an elastic metal core and an outer envelope (13, 23) of ductile material, into which is inserted the metal core (12, 22), while the gasket (10), when idle, has a closed circular section defining a middle axis (M), i.e., a straight line passing through the geometrical centre of the idle gasket section which has 2 clearance surfaces (16, 26) placed opposite each other and each of which has at least one projecting part (14, 24) and whose apex is designed to come into tight contact with an object (1) under the effect of a determined tightening force, characterized by the fact that, when idle, the projecting parts (14, 24) are offset slightly with respect to middle axis (M) of the gasket (10, 20).

2. A gasket according to claim 1, characterized by the fact that the two clearance surfaces (16, 26) are parallel to one another and each is parallel to the axis of symmetry of the projecting part (14, 24) associated with them.

3. A gasket according to claim 1, characterized by the fact that the height (h) of the projecting parts (14, 24) is included between 0.025 mm and 0.50 mm.

4. A gasket according to claim 1, characterized by the fact that on each clearance surface (26) it has two projecting parts (24) placed either side of middle axis (M).

5. A gasket according to claim 1, characterized by the fact that the projecting parts (14, 24) are generally triangular in shape.

6. A gasket according to claim 1, characterized by the fact that the projecting parts are generally trapezoidal in shape.

7. A gasket according to claim 1, characterized by the fact that the projecting parts are generally elliptical in shape.

8. A gasket according to claim 1, characterized by the fact that the projecting parts are generally rectangular in shape.

9. A gasket according to claim 1, characterized by the fact that it is generally annular in shape.

10. A gasket according to claim 9, characterized by the fact that it is generally elliptical in shape.

11. A gasket according to claim 9, characterized by the fact that it is generally triangular in shape.

12. A gasket according to claim 9, characterized by the fact that it is generally rectangular in shape.
